(19) United States
(12) Patent Application Publication
(10) Pub. No.: US 2025/0348137 A1
(43) Pub. Date: Nov. 13, 2025

(54) ATTENTION EXTRACTION SYSTEM AND ATTENTION EXTRACTION METHOD

(71) Applicant: INFORMATION SYSTEM ENGINEERING, Tokyo (JP)

(72) Inventor: Satoshi KURODA, Tokyo (JP)

(21) Appl. No.: 18/869,057

(22) PCT Filed: Apr. 19, 2024
(86) PCT No.: PCT/JP2024/015567

§ 371 Date: Nov. 25, 2024

(30) Foreign Application Priority Data
May 11, 2023 (JP) 2023-078265

(51) Int. Cl. G06F 3/01; G06V 20/20; G09B 5/02

(52) U.S. Cl. CPC G06F 3/013; G06V 20/20; G09B 5/02

(57) ABSTRACT

In an attention extraction system (100) for extracting attention information on work, an attention extraction device (1) includes an acquisition device that acquires video information and coordinate information in time series order in association with the work, an identification device that obtains a viewpoint displacement of an instructor in a visual field range to identify a gaze mode of the instructor, an extraction device that sets a gazed region based on the gaze mode, and extracts a gazed image of a work target that the instructor has gazed at in the gazed region, and a storing device that associates the extracted gazed image with the visual field range, the viewpoint displacement, and the gaze mode, and stores them in a database as attention information on the work.

### TECHNICAL FIELD

The present invention relates to an attention extraction system and an attention extraction method for extracting attention information on work.

### BACKGROUND ART

Conventionally, as a technique relating to attention extraction, for example, there have been proposed a skill transmission system of Patent Document 1 and a wiring work assist system disclosed in Patent Document 2.

In the skill transmission system disclosed in Patent Document 1, machine learning is performed on first image data and line-of-sight data of the eyesight of a first user based on teaching data to extract feature data of an image, and information on an attention point of the first user in a first image is input as teaching data and registered in association with the feature data. Second image data of the eyesight of a second user is transmitted to a server, attention point data associated with the feature data corresponding to a second image is read, and assist display data is generated and transmitted to a glasses-type terminal of the second user. At the glasses-type terminal of the second user, the information on the attention point is displayed so as to overlap the eyesight of the second user based on the assist display data.

In the wiring work assist system disclosed in Patent Document 2, characters and colors are deciphered by image processing within a visual range of a worker with an line-of-sight tracking device that tracks a line of sight of the worker and an imaging device that takes an image of wiring and the like as a work target. Patent Document 2 discloses a portable work management device that includes an image processing unit configured to introduce information on a target stored in a data storage and management unit to the worker, and that stores a work termination signal from a limit switch provided at a work tool and an image of the work target.

Patent Document 1: JP-A-2017-191490

Patent Document 2: JP-A-2015-061339

### DISCLOSURE OF THE INVENTION

### Problems to be Solved by the Invention

Here, in Patent Document 1, it is premised that lines of sight are coordinated between users to transmit skills and the like between the users. That is, it is difficult to obtain a state of gaze based on a gaze time, a gaze transition, and the like of a viewpoint to extract appropriate attention information and provide it to a worker. Furthermore, the identification of an attentive action indicating what and in what situation an instructor has gazed at is not described or suggested.

In Patent Document 2, it is premised that the line of sight of the worker is associated with the work target and the information on the target is introduced to the worker. That is, it is difficult to obtain a state of gaze based on a gaze time, a gaze transition, and the like of a viewpoint to extract appropriate attention information and provide it to a worker. Furthermore, the identification of an attentive action indicating what and in what situation an instructor has gazed at is not described or suggested.

Accordingly, the present invention has been devised in consideration of the above-described problems, and it is an object of the present invention to provide an attention extraction system and an attention extraction method for obtaining a state of gaze of an instructor and attempting extracting and providing appropriate attention information.

### Solutions to the Problems

An attention extraction system according to a first invention is an attention extraction system for extracting attention information on work. The attention extraction system includes acquisition means, identification means, extraction means, and storing means. The acquisition means acquires video information in a visual field range of an instructor who performs the work and coordinate information indicating a viewpoint that the instructor gazes at in the visual field range in time series order in association with the work. The identification means obtains a viewpoint displacement of the instructor in the visual field range based on the video information and the coordinate information acquired by the acquisition means and identifies a gaze mode of the instructor. The extraction means sets a gazed region based on the gaze mode identified by the identification means, and extracts a gazed image of a work target that the instructor has gazed at in the gazed region. The storing means associates the gazed image extracted by the extraction means with the visual field range, the viewpoint displacement, and the gaze mode, and stores them in a database as attention information on the work.

In the attention extraction system according to a second invention, which is in the first invention, the acquisition means further includes determination means and display means. The determination means determines right/wrong of the work target included in the gazed image. The display means displays a determination result of the determination means.

The attention extraction system according to a third invention, which is in the second invention, further includes a database that stores an association between past gazed image information acquired in advance and reference information indicating the right/wrong of the work target associated with the gazed image. The determination means refers to the database to determine the right/wrong of the work target, and acquires response information corresponding to a result of the determination from the database. The display means further outputs the response information acquired by the determination means.

The attention extraction system according to a fourth invention, which is in the second invention, further includes input means that inputs the response information output by the determination means. The storing means associates the response information input by the input means with the gazed image, and stores them as an attention data set including a setting condition for recognizing a gaze target.

In the attention extraction system according to a fifth invention, which is in the second invention, the video information acquired by the acquisition means includes recording date and time information and recording location information of the work performed by the instructor, and recording control information regarding an acquisition operation of the video information, and the display means displays the recording date and time information, the recording location information, and the recording control information in a center of the visual field range before the acquisition of the video information by the acquisition means, and switches the display to indicate only the recording control information at a corner of the visual field range during the acquisition of the video information.

In the attention extraction system according to a sixth invention, which is in the second invention, the display means further includes an attention information display area that displays an acquisition display area and an attention display area to the worker who performs the work while the acquisition display area and the attention display area are mutually switched. The acquisition display area indicates a type of the acquisition means that acquires the video information, a type of the attention data set stored in the database, and an instruction for causing each worker to select a start of the work. The attention display area indicates response information corresponding to the gazed image of the worker and attention information based on the attention data set after the selection. The attention information indicated in the attention display area includes nudge information indicated at a timing of at least any of a work start, a middle of the work, or a work end corresponding to work progress of the worker. Information including at least any of the response information, the attention information, or the nudge information indicated in the attention information display area is distributed to be displayed depending on a gaze state of the worker who performs the work based on the attention data set and the determination result of the determination means.

An attention extraction method according to a seventh invention includes an acquiring step of acquiring video information in a visual field range of an instructor who performs the work and coordinate information indicating a viewpoint that the instructor gazes at in the visual field range in time series order in association with the work; an identifying step of identifying a gaze mode of the instructor as a wide visual field mode and a vigilant mode based on the video information and the coordinate information acquired by the acquiring step, the wide visual field mode being identified when the coordinate information in time series order indicating a viewpoint displacement of the instructor in the visual field range is aggregated in a center of the visual field range, the vigilant mode being identified when the coordinate information in time series order indicating the viewpoint displacement of the instructor in the visual field range is decentralized to an outside of the center of the visual field range; an extracting step of setting a gazed region based on the gaze mode identified by the identifying step, and extracting a gazed image of a work target that the instructor has gazed at in the gazed region; and a storing step of associating the gazed image extracted by the extracting step with the visual field range, the viewpoint displacement, and the gaze mode, and storing them in a database as attention information on the work. The steps are executed by a computer.

### EFFECTS OF THE INVENTION

According to the first invention to the seventh invention, the identification means obtains the viewpoint displacement of the instructor in the visual field range based on the video information and the coordinate information to identify the gaze mode of the instructor. Therefore, the extraction means can set the gazed region based on the identified gaze mode and extract the gazed image of the work target that the instructor has gazed at in the gazed region. Accordingly, since the gazed image indicating what and in what situation the instructor has gazed at can be extracted based on a gaze time and a gaze transition of the viewpoint, the gaze state can be accurately obtained, and appropriate attention information can be provided.

Especially according to the second invention, the gazed region includes the wide visual field mode and the vigilant mode of the instructor. Therefore, the wide visual field mode in which the viewpoint displacement of the instructor is aggregated in the center of the visual field range and the vigilant mode in which the viewpoint displacement of the instructor is decentralized to the outside of the center of the visual field range can be set. Accordingly, the gazed image indicating what and in what situation the instructor has gazed at can be extracted.

Especially according to the third invention, the acquisition means further includes the determination means. Therefore, the right/wrong of the work target included in the gazed image can be determined. Accordingly, the gaze states of the instructor and the worker can be accurately obtained, and the appropriate attention information can be provided.

Especially according to the fourth invention, the database stores the association between the past gazed image information acquired in advance and the reference information indicating the right/wrong of the work target associated with the gazed image. Therefore, the determination means can determine the right/wrong of the work targe by referring to the database, and the display means can output the response information corresponding to the determination result. Accordingly, the gaze state of the worker can be accurately obtained, and the appropriate attention information can be provided.

Especially according to the fifth invention, the input means inputs the response information output by the determination means. Therefore, the storing means can associate the response information with the gazed image, and store them as the attention data set including the setting condition for recognizing the gaze target. Accordingly, the gaze state can be accurately obtained, and the appropriate attention information can be provided.

Especially according to the sixth invention, the display means switches the information displayed in the visual field range before the acquisition and during the acquisition of the video information. Therefore, the recording date and time information, the recording location information, and the recording control information of the work of the instructor are displayed in the center of the visual field range before the acquisition of the video information, and only the recording control information is displayed at the corner of the visual field range during the acquisition. Accordingly, the acquisition of the video information and the extraction of the gazed image of the instructor performing the work can be executed without putting a burden on the instructor.

Especially according to the seventh invention, the display means switches the display between the acquisition display area and the attention display area. Therefore, the response information, the attention information, or the nudge information can be distributed to be displayed depending on the gaze state of the worker performing the work based on the attention data set and the determination result. Accordingly, the gaze state of the worker can be accurately obtained, and the appropriate attention information can be provided.

According to an eighth invention, the identifying step obtains the viewpoint displacement of the instructor in the visual field range based on the video information and the coordinate information to identify the gaze mode of the instructor. Therefore, the extracting step can set the gazed region based on the identified gaze mode, and extract the gazed image of the work target that the instructor has gazed at in the gazed region. Accordingly, since the gazed image indicating what and in what situation the instructor has gazed at can be extracted based on the gaze time and the gaze transition of the viewpoint, the gaze state can be accurately obtained, and the appropriate attention information can be provided.

### BRIEF DESCRIPTION OF THE DRAWINGS

FIG. 1 is a schematic diagram illustrating an exemplary configuration of an attention extraction system according to the embodiment.

FIG. 2 is a schematic diagram illustrating exemplary attention extraction by an instructor and work evaluation by a worker in an attention extraction system 100 according to the embodiment.

FIGS. 3A to 3C are schematic diagrams illustrating an exemplary attention extraction method according to the embodiment.

FIG. 4A is a schematic diagram illustrating an exemplary configuration of an attention extraction device, and FIG. 4B is a schematic diagram illustrating exemplary functions of the attention extraction device.

FIG. 5 is a schematic diagram illustrating an exemplary database according to the embodiment.

FIG. 6 is a schematic diagram illustrating a first modification of the database according to the embodiment.

FIG. 7 is a schematic diagram illustrating exemplary data tables stored in the database according to the embodiment.

FIG. 8 is a schematic diagram illustrating an exemplary flowchart of an attention extraction method according to the embodiment.

FIGS. 9A to 9E are schematic diagrams illustrating an exemplary attention extraction method according to the embodiment.

FIG. 10A and FIG. 10B are schematic diagrams illustrating exemplary displays of a worker device according to the embodiment.

FIG. 11 is a schematic diagram illustrating an exemplary display of the attention extraction device according to the embodiment.

FIGS. 12A to 12E are schematic diagrams illustrating exemplary displays of a worker terminal according to the embodiment.

### DESCRIPTION OF PREFERRED EMBODIMENTS

The following describes an exemplary attention extraction system and attention extraction method of embodiments of the present invention with reference to the drawings.

### The Embodiment: Attention Extraction System 100 and Attention Extraction Method

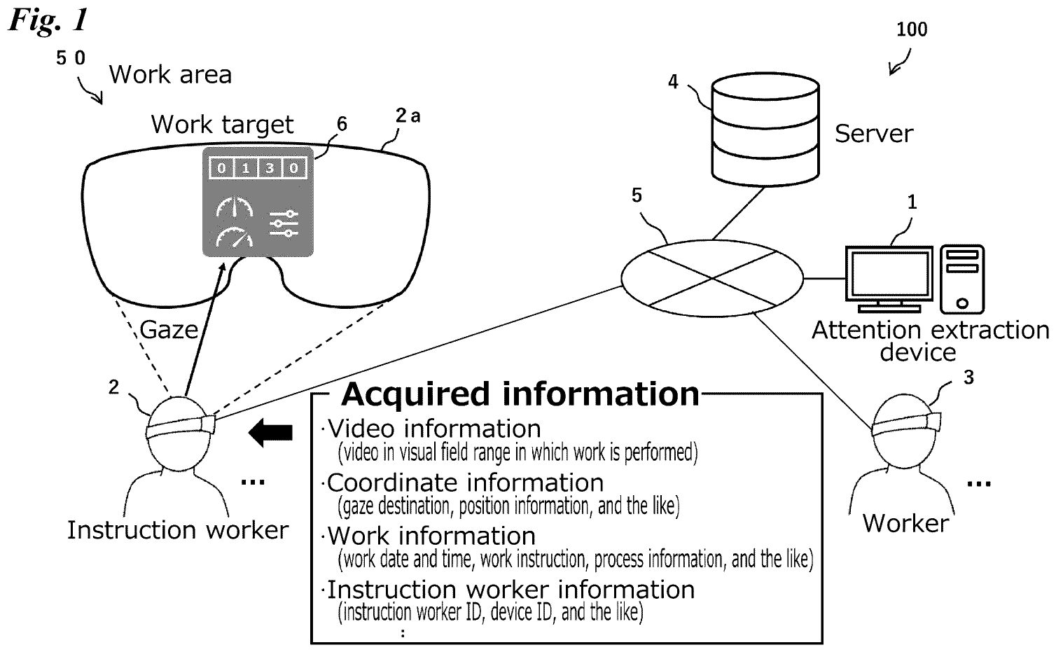

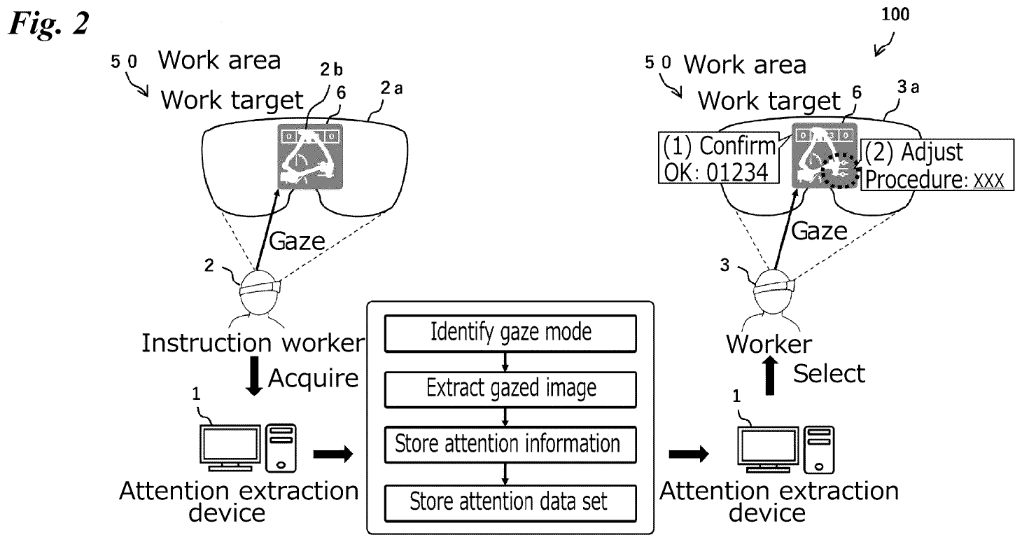

With reference to FIG. 1 and FIG. 2, an exemplary configuration of an attention extraction system 100 according to the embodiment is described. FIG. 1 is a schematic diagram illustrating an exemplary configuration of the attention extraction system 100 according to the embodiment, and FIG. 2 is a schematic diagram illustrating exemplary attention extraction by an instructor and work evaluation by a worker in the attention extraction system 100 according to the embodiment.

The attention extraction system 100 is used for extracting a work target to which an instructor pays attention using video information in a visual field range of the instructor who performs work and coordinate information indicating a viewpoint at which the instructor gazes in the visual field range. In the attention extraction system 100, for various kinds of information including the video information, the coordinate information, and work information on the work, the video information and the coordinate information can be acquired under various conditions in the visual field range of the instructor.

The attention extraction system 100 includes, for example, as illustrated in FIG. 1, an attention extraction device 1, an instructor device 2, a worker device 3, and a server 4, and for example, a plurality of the instructor devices 2 and a plurality of the worker devices 3 may be provided in, for example, a work area 50. The attention extraction system 100 may transmit and receive various kinds of information to and from the attention extraction device 1, the instructor device 2, the worker device 3, the server 4, other user devices (not illustrated), and the like via, for example, a publicly known communications network 5.

The attention extraction system 100, for example, acquires a viewpoint displacement 2b of a viewing destination at which the instructor gazes included in a visual field range 2a of the instructor via the instructor device 2 that the instructor wears. Information that the attention extraction system 100 acquires from the instructor includes, for example, the video information (video in the visual field range where the work is performed), the coordinate information (viewpoint, position information, and the like), the work information (work date and time, work instruction, process information, and the like), and instructor information (instructor ID, device ID, and the like). Additionally, various kinds of information on work performed by the instructor (assignment work, group work, and the like) may be included.

For example, as illustrated in FIG. 2, the attention extraction system 100 acquires the video information in the visual field range of the instructor performing the work and the coordinate information indicating the viewpoint at which the instructor gazes in the visual field range in time-series order in association with the work performed by the instructor from the instructor device 2 that the instructor wears. For the acquisition of the video information and the coordinate information, for example, a publicly known eye-tracking technology or a technology for acquiring a viewpoint equipped in a head-mounted display, smart glasses, or the like may be used.

The attention extraction system 100, for example, acquires the video information and the coordinate information by the above-described technique equipped in the instructor device 2, identifies a gaze mode of the instructor by the attention extraction device 1, and extracts a gazed image based on the identified gaze mode. The attention extraction system 100, for example, associates the extracted gazed image of the instructor with reference information associated with the gazed image, and stores them in a database as an attention data set. The attention extraction system 100, for example, may refer to the database, acquire attention information associated with the reference information, and display the attention information on the worker device 1 of the worker who uses the attention data set.

Then, for example, based on the attention data set selected by the worker, the attention extraction system 100 evaluates the work of the worker based on the video information of a work target 6 included in a visual field range 3a of the worker, numerical information, the coordinate information, and the like of the viewpoint displacement of the viewing destination, and for example, identifies the work target 6 as gaze information based on an evaluation result. Further, for example, the attention extraction system 100 acquires response information, such as “(1) Confirm” and “(2) Adjust,” and displays the response information superimposed on the visual field range 3a of the worker device 3 together with an actual display. Respective configurations of the attention extraction device 1, the instructor device 2, and the worker device 3 will be described later in detail.

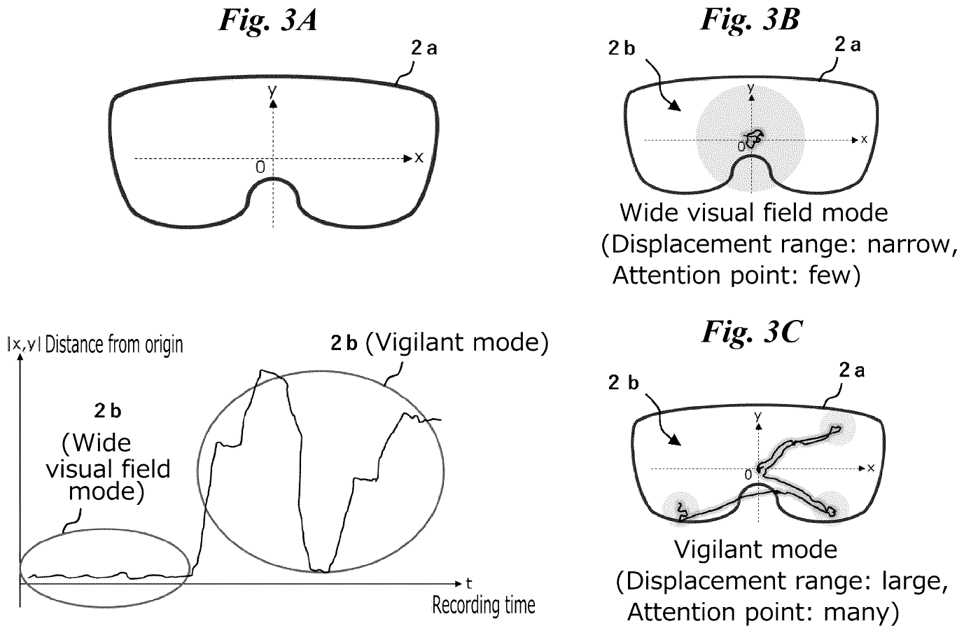

Here, with reference to FIG. 3, the identification of the gaze mode of the instructor is described. The attention extraction system 100 identifies the gaze mode of the instructor by an attention extraction method, for example, as illustrated in FIGS. 3A to 3C. For example, as illustrated in FIG. 3A, the attention extraction system 100 identifies the gaze mode in the visual field range of the instructor based on the video information in the visual field range 2a and the coordinate information (x-axis, y-axis) of the viewpoint displacement of the instructor acquired by the instructor device 2.

The attention extraction system 100 obtains the viewpoint displacement of the instructor in the visual field range 2a from coordinates based on the video information and the coordinate information acquired via the instructor device 2, and identifies the gaze mode of the instructor. For example, as illustrated in FIG. 3B, the attention extraction system 100 may identify the gaze mode of the instructor as a “wide visual field mode” when a feature of a line-of-sight displacement of the instructor is that “the displacement range is narrow (concentration)” and “the number of attention points of the viewpoint is small.” For example, as illustrated in FIG. 3C, the attention extraction system 100 may identify the gaze mode of the instructor as a “vigilant mode” when the feature of the line-of-sight displacement of the instructor is that “the displacement range is wide (decentralization)” and “the number of attention points of the viewpoint is large.”

The attention extraction system 100 sets a gazed region at which the instructor has gazed based on the identified gaze mode, extracts a gazed image of the work target at which the instructor has gazed in the set gazed region, and stores the extracted gazed image in association with the visual field range, the viewpoint displacement, and the gaze mode in the database of the server 4 or the like as the attention information in the work of the instructor. A plurality of instructors and a plurality of workers may be involved, for example, a plurality of instructors and workers may work in the same process, and the attention extraction system 100, for example, may assign one work process of the instructor to a plurality of workers so that they share the work process to work.

The assignment of the instructors and the workers by the attention extraction system 100 is determined, for example, based on the number of processes of the work process, the degree of difficulty, skills of the workers, the work deadline, and the like. Additionally, for example, the assignment may be made by an evaluator via the attention extraction device 1, it is arbitrary how many workers are assigned to which work and how the workers are arranged, and it may be appropriately identified.

### <Attention Extraction Device 1>

The attention extraction device 1, for example, obtains the viewpoint displacement of the instructor in the visual field range based on the video information in the visual field range of the work performed by the instructor and the coordinate information indicating the viewpoint at which the instructor gazes in the visual field range, which are acquired by the instructor device 1, and identifies the gaze mode of the instructor.

The gazed region identified by the identification means includes, for example, the wide visual field mode in which the viewpoint displacement of the instructor is in a range of a visual field radius of 5 degrees to 20 degrees and aggregated in the center of the visual field range and the vigilant mode in which the viewpoint displacement of the instructor is within the visual field radius of 4 degrees and decentralized to the outside of the center of the visual field range.

For example, as illustrated in FIG. 3B described above, the attention extraction device 1 identifies the case in which the feature of the line-of-sight displacement of the instructor is that “the displacement range is narrow (concentration)” and “the number of attention points of the viewpoint is small” as the “wide visual field mode.” Meanwhile, as illustrated in FIG. 3C described above, the attention extraction device 1 identifies the case in which the feature of the line-of-sight displacement of the instructor is that “the displacement range is wide (decentralization)” and “the number of attention points of the viewpoint is large” as the “vigilant mode.”

The attention extraction device 1, for example, sets the gazed region based on the identified gaze mode, and extracts the gazed image of the work target at which the instructor has gazed in the gazed region. The attention extraction device 1, for example, associates the extracted gazed image with the visual field range, the viewpoint displacement, and the gaze mode, and stores them in the database as attention information on the work.

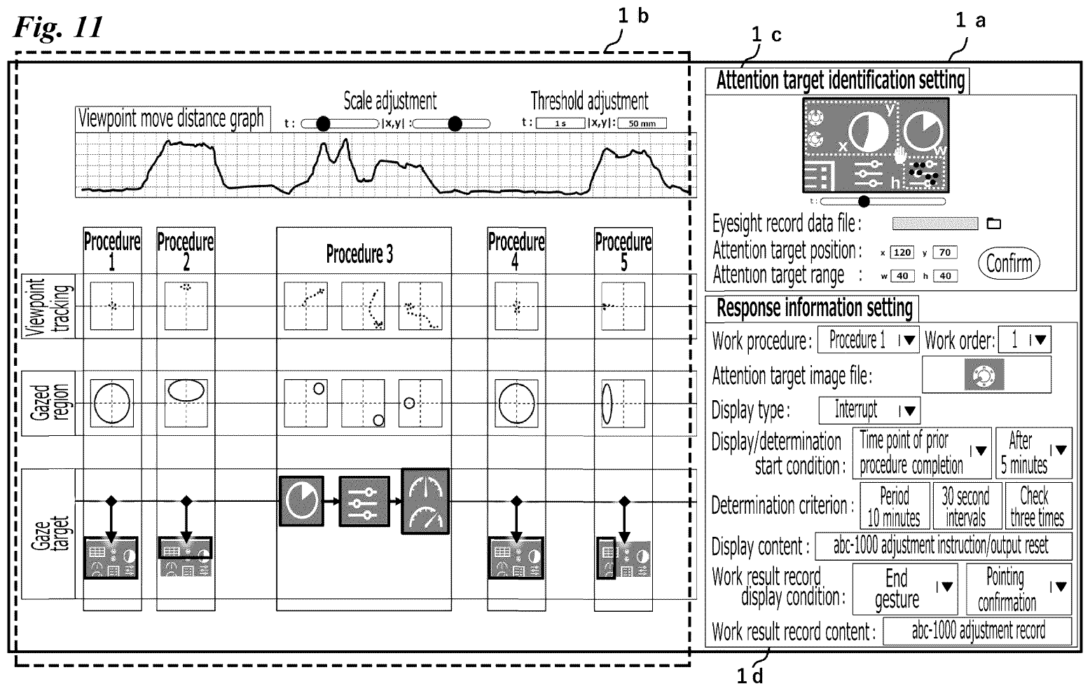

Here, FIG. 11 illustrates an exemplary attention extraction device screen 1a of the attention extraction device 1 in the attention extraction system 100. FIG. 11 illustrates, for example, a screen operated by an evaluator, on which various kinds of information acquired by the instructor device 1 is displayed.

The attention extraction device 1 displays a gaze monitoring area on the attention extraction device screen 1a. The gaze monitoring area includes, for example, at least a gaze display area 1b (viewpoint move distance graph, viewpoint tracking, gazed region, gaze target, and the like) indicating the coordinate information, the gazed region, the gazed image, and a gaze transition in time series order by referring to the database, a target setting area 1c (gaze target evaluation, recognizer generation, and the like) indicating setting information for performing setting on the gazed image indicated in the gaze display area 1b, and a determination setting area 1d (response information setting and the like) indicating a determination condition of the setting information indicated in the target setting area 1c.

The attention extraction device 1, for example, accepts conditions, numerical values, and the like regarding various kinds of settings and adjustments from the evaluator via a setting item menu displayed on the attention extraction device screen 1a. The attention extraction device 1, for example, performs the setting and the adjustment of the display and the condition of the gaze display area 1b, the target setting area 1c, and the determination setting area 1d based on the accepted various kinds of conditions and numerical values.

The attention extraction device 1, for example, determines whether the work target included in the gazed image of the instructor is right or wrong according to the various kinds of conditions accepted from the evaluator via the setting item menu displayed on the attention extraction device screen 1a. The attention extraction device 1 may display a determination result on the instructor device 2 or the worker device 3.

The attention extraction device 1, for example, accepts an input of the response information from the evaluator via the setting item menu displayed on the attention extraction device screen 1a. The attention extraction device 1 may not only accept an input of additional response information, but also update or delete the existing condition, setting, response information, and the like, and store them in the database of the server 4.

The attention extraction device 1, for example, may associate the input response information with the gazed image, generate an attention data set including a setting condition for recognizing the gaze target, and store the generated attention data set in the database of the server 4.

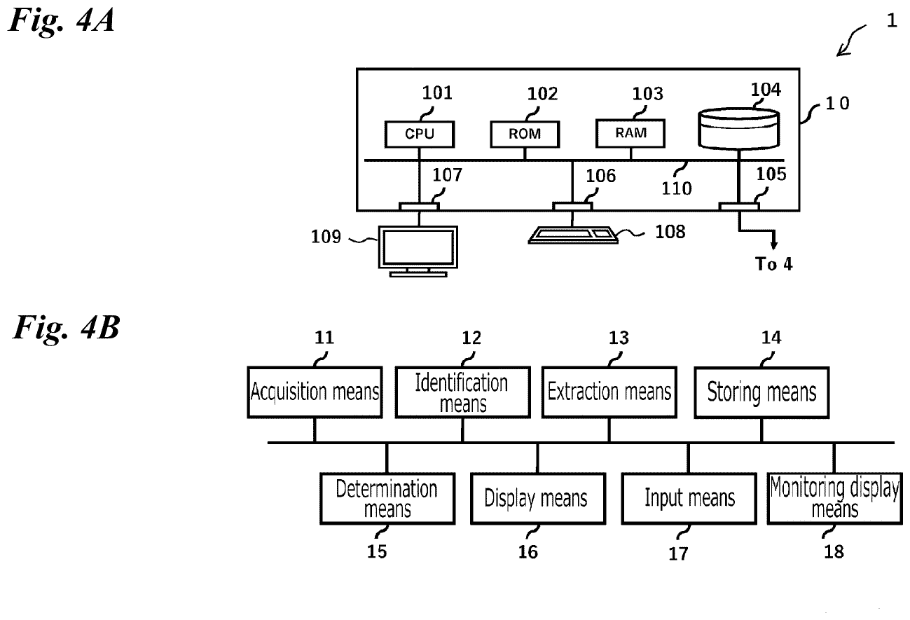

FIG. 4A is a schematic diagram illustrating an exemplary configuration of the attention extraction device 1. As the attention extraction device 1, a single board computer, such as Raspberry Pi (registered trademark), is used, and additionally, for example, a publicly known electronic device, such as a personal computer (PC), may be used. The attention extraction device 1 includes, for example, a housing 10, a Central Processing Unit (CPU) 101, a Read Only Memory (ROM) 102, a Random Access Memory (RAM) 103, a storage unit 104, and I/Fs 105 to 107. The components 101 to 107 are mutually connected by an internal bus 110.

The CPU 101 controls the entire attention extraction device 1. The ROM 102 stores operation codes of the CPU 101. The RAM 103 is a working area used during the operation of the CPU 101. The storage unit 104 stores various kinds of information, such as a learning model and a database. As the storage unit 104, for example, in addition to a SD memory card, publicly known data storage media, such as a Hard Disk Drive (HDD) and a Solid State Drive (SSD), are used.

The I/F 105 is a publicly known interface for transmitting and receiving various kinds of information to and from the instructor device 2, the worker device 3, the server 4, the communications network 5, and the like connected corresponding to the purpose of use. For example, a plurality of the I/Fs 105 may be provided.

The I/F 106 is a publicly known interface for transmitting and receiving various kinds of information to and from an input part 108 connected corresponding to the purpose of use. As the input part 108, for example, a keyboard is used, and an administrator or the like who manages the attention extraction system 100 inputs or selects various kinds of information or a control command and the like of the attention extraction device 1 via the input part 108.

The I/F 107 is a publicly known interface for transmitting and receiving various kinds of information to and from a display part 109 connected corresponding to the purpose of use. The display part 109 outputs various kinds of information stored in the storage unit 104, a processing status of the attention extraction device 1, and the like. As the display part 109, for example, a display is used, and for example, a touch panel type may be used. In this case, the display part 109 may include the input part 108.

As the I/F 105 to I/F 107, for example, the same one may be used, and for example, a plurality of I/Fs may be used for each of the I/F 105 to I/F 107. At least any of the instructor device 2, the worker device 3, the server 4, the communications network 5, the input part 108, and the display part 109 may be removed depending on the situation.

<Storing unit 14 (Database)>

A storing unit 14, for example, stores various kinds of databases in the storage unit 104. The storing unit 14 stores an association between past evaluation target information acquired in advance and reference information associated with the past evaluation target information, and for example, a learning model having the association is stored. The storing unit 14, for example, may be included in the instructor device 2, the worker device 3, and the server 4.

The storing unit 14, for example, records an attentive action (attention point, viewpoint, and the like) of the instructor when acquiring the work of the instructor. The attention extraction system 100, for example, may determine the gaze mode based on the information, such as the gazed image, the visual field range, and the viewpoint displacement, acquired via the instructor device 2. The attention extraction system 100, for example, may identify the case in which the feature of the line-of-sight displacement of the instructor is that “the displacement range is narrow (concentration)” and “the number of attention points of the viewpoint is small” as the “wide visual field mode,” meanwhile, as illustrated in FIG. 3C described above, identify the case in which the feature of the line-of-sight displacement of the instructor is that “the displacement range is wide (decentralization)” and “the number of attention points of the viewpoint is large” as the “vigilant mode,” and store them in the storing unit 14 of the server 4 or the like as the attention information on the work of the instructor.

The storing unit 14, for example, acquires information on the work of the instructor by various interfaces (not illustrated) of an input system included in the instructor device 2, and stores various kinds of information acquired by input devices including a gesture, a sound, and a line of sight. The attention extraction system 100, for example, stores the various kinds of information acquired via the input devices in the storing unit 14 each in association with information on the instructor and the information on the work of the instructor. The attention extraction system 100, for example, may record the various kinds of information as necessary corresponding to a recording instruction, such as a recording start and a recording end, from the instructor via the instructor device 2.

The storing unit 14, for example, sequentially records a coordinate position provided to a viewpoint supplemented by the instructor, a change of the coordinate position, a change rate, and the like via the instructor device 2, and additionally, may record, for example, a position and a direction of the head in a work space coordinate with the whole spatial layout of a place in which each work is performed. The attention extraction system 100 may acquire the various kinds of information recorded for each spatial layout by, for example, a publicly known imaging device, such as a 360° camera, a security camera, or a network camera, and store them in the storing unit 14 in association with information indicative of the coordinate position of the head of the instructor and the change of the coordinate position, and the like.

The storing unit 14 may record imaging data and various kinds of data recorded in association with the photographing data as the attention data set in the work of the instructor after the end of the recording in the database. For example, attention and know-how are evaluated by the evaluator via the attention extraction device 1, and the attention data set is registered (recorded) in the storing unit 4 as an attention target recognizer and response information in monitoring of the attention target.

Here, for example, the attention target recognizer is a device generated using evaluated attention target video by the attention extraction system 100, and may be, for example, a publicly known image processing program of pattern matching and the like or an image recognition model. The image processing program or the image recognition model may be, for example, installed in the worker device 3 that the worker wears when performing the work. This allows the worker, for example, to evaluate the attention information on the work based on the time series video information and coordinate information acquired via the worker device 3 when performing the work.

The storing unit 14 may further include, for example, a database storing an association between past gazed image information acquired in advance and reference information indicating right/wrong of the work target associated with the gazed image. The storing unit 14 may be, for example, referred to by a determination unit 15 and used in the determination of right/wrong of the work target in the work of the instructor. The determination unit 15 may, for example, acquire the corresponding response information depending on the result of the determination. A display unit 16 may, for example, further output the corresponding response information from the storing unit 14 depending on the contents determined by the determination unit 15.

The storing unit 14 may, for example, register a gaze target recognizer acquired by the instructor device 2 and evaluated as attention know-how by an evaluation unit 15 and the response information in the monitoring of the gaze target as the attention data set of the work in the worker device 13.

The storing unit 14 may, for example, store the past evaluation target information acquired by the instructor device 2 and the reference information. The association is, for example, established by machine learning using a plurality of sets of learning data including the past evaluation target information and the reference information as one set of the learning data. As a learning method, for example, deep learning, such as a convolutional neural network, is used.

In this case, for example, the association indicates a degree of connection between multiple pieces of information and multiple pieces of information (a plurality of pieces of data included in the past evaluation target information and a plurality of pieces of data included the reference information).

The association is appropriately updated in the process of the machine learning. That is, the association indicates, for example, a function optimized based on past image data A, response information A, and the reference information. Therefore, the evaluation result of the evaluation target information is generated using the association established based on all the evaluation results of the evaluation target information in the past. This enables generating the optimal evaluation result even when the evaluation target information has a configuration combined with other pieces of the image data A and the response information A, or the like.

The evaluation target information stored in the storing unit 14 may be same as or similar to, and further, dissimilar to the past evaluation target information. This allows the attention extraction system 100 to quantitatively generate the optimal evaluation result. The attention extraction system 100 can enhance generalization capability when performing the machine learning, and can attempt improving the evaluation accuracy of unknown evaluation target information.

The association may include, for example, a plurality of degrees of association indicating the degree of connection between a plurality of pieces of data included in the past evaluation target information and a plurality of pieces of data included in the reference information. The degree of association can, for example, correspond to a weight variable when the learning model is established with a neural network.

The past evaluation target information indicates the same kind of information as the above-described evaluation target information. The past evaluation target information includes, for example, a plurality of pieces of the evaluation target information acquired when the image data A was evaluated in the past.

The reference information is associated with the past evaluation target information, and indicates information on the image data A and the response information A. The reference information indicates, for example, a working range, a work instruction, a work procedure, and contents of a post-process and related work for the image data A, contents of assigned work and alternative work of another worker working in the same area, and evaluation based on the relation between various kinds of work and the mutual influence (for example, “CONFIRMATION,” “ADJUSTMENT,” “WATCH!,” “DETERMINATION,” “RESPONSE,” and the like). Further, the reference information may include various kinds of information on the progress of a work process, a check list, a featured image, the priority of displayed information, a combination of display and non-display, a numerical value, data, distribution, and the like. The specific contents included in the reference information can be appropriately set.

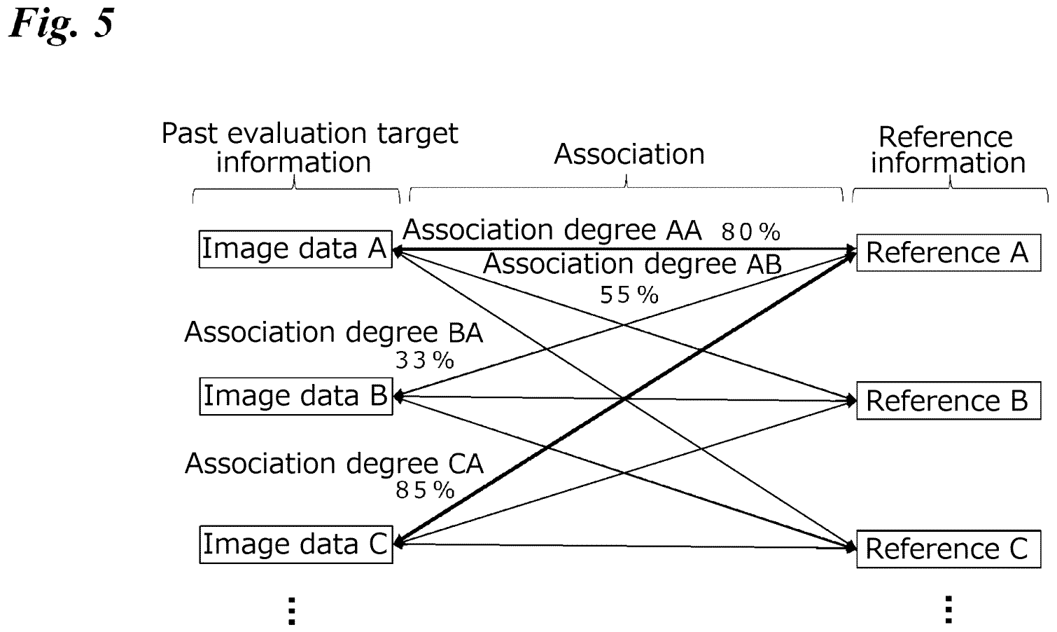

For example, as illustrated in FIG. 5, the association may indicate the degree of connection between the past evaluation target information and the reference information. In this case, by using the association, a plurality of pieces of data (in FIG. 5, “Image data A” to “Image data C”) included in the past evaluation target information can be each stored in association with the degree of relation with a plurality of pieces of data (in FIG. 5, “Reference A” to “Reference C”) included in the reference information. Therefore, for example, one piece of data included in the past evaluation target information can be associated with a plurality of pieces of data included in the reference information via the association, and thus the generation of the multifaceted evaluation result can be achieved.

For example, the association includes a plurality of degrees of association associating a plurality of pieces of data included in the past evaluation target information with a plurality of pieces of data included in the reference information. The degree of association is indicated in percentage or three or more levels, such as 10 levels or 5 levels, and indicated by, for example, a feature (for example, the thickness or the like) of a line. For example, the “image data A” included in the past evaluation target information has an association degree AA of “80%” with the “reference A” included in the reference information, and has an association degree AB of “55%” with the “reference B” included in the reference information. That is, the “association degree” indicates the degree of connection between the respective pieces of data, and for example, it is indicated that the connection between the respective pieces of data becomes strong as the association degree increases. When the association is established by the above-described machine learning, the association may be set to have an association degree of three or more levels.

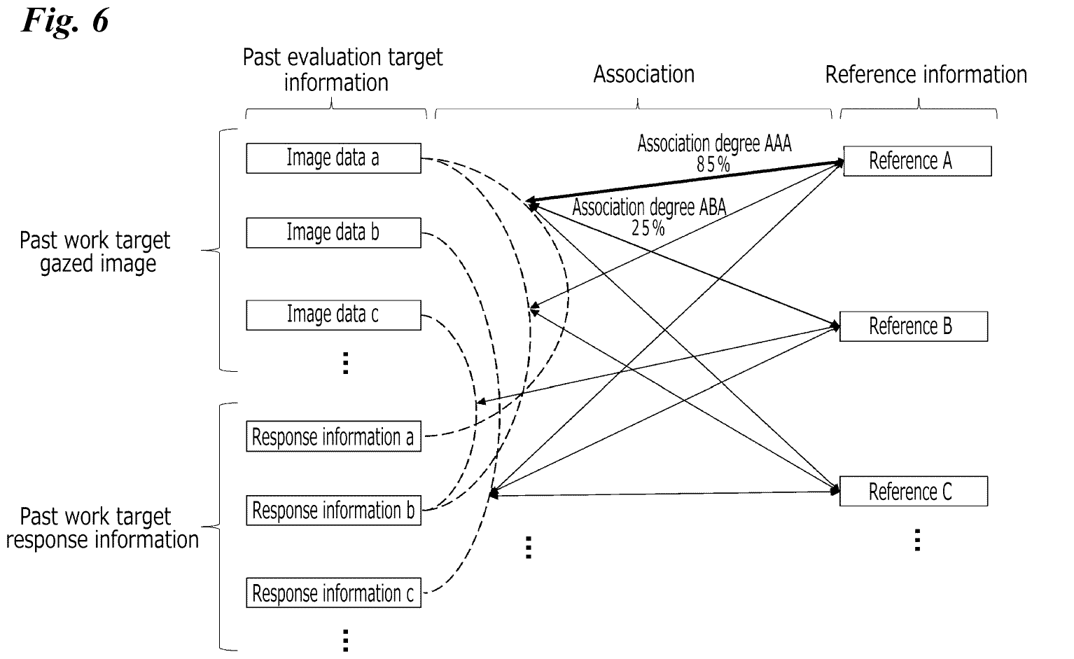

For the past evaluation target information, for example, as illustrated in FIG. 6, the past evaluation target information may be divided into a past gazed image of the work target and past response information of the work target and stored in the database. In this case, the association degree is calculated based on a relation between a combination of image data of the past gazed image and the past response information and the reference information. For example, in addition to the above, the past evaluation target information may be stored in the database by dividing the past countermeasure information.

For example, a combination of “image data a” included in the past gazed image and “response Information a” included in the past response information has an association degree AAA of “85%” with the “reference A,” and has an association degree ABA of “25%” with the “reference B.” In this case, data of past target data and past response information can be each independently stored. Therefore, in the generation of the evaluation result, the accuracy can be improved, and the range of options can be expanded.

The past evaluation target information may include, for example, composite data and a degree of similarity. The composite data is indicated by three or more levels of the degree of similarity to the past target data or the past response information. The composite data is stored in the database in a format of a numerical value, a matrix, a histogram, or the like, and further, may be stored, for example, in a format of an image, a character string, and the like.

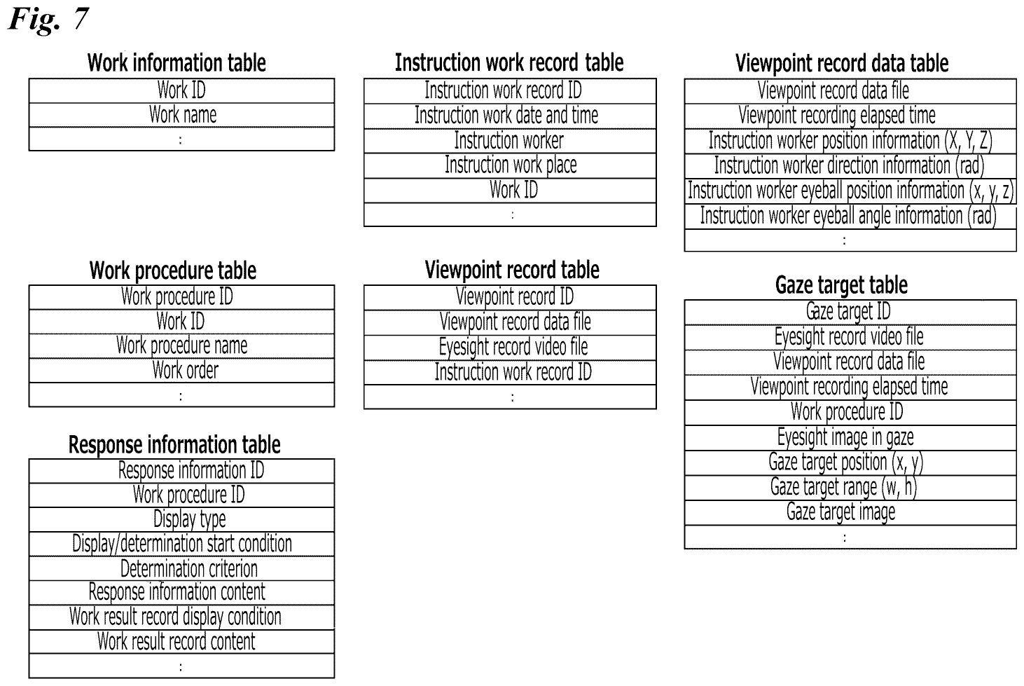

Here, with reference to FIG. 7, an exemplary database according to the embodiment is described. The database stores, for example, various kinds of information on the instructor (instruction worker), the evaluator, the worker, and the like who are users of the attention extraction system 100, and further, information on the contents and the processes of various kinds of work, and a plurality of data sets used by the worker, as the attention data set.

In the attention data set, for example, information in respective data tables, and various kinds of information on the works of the instructor, the worker, and the like, the evaluation by the evaluator, and the like are associated with respective pieces of data. The evaluation by the evaluator is, for example, input by an input unit 17. The attention data set stores, for example, at least a “work information table,” a “work procedure table,” a “response information table,” an “instruction work record table,” a “viewpoint record table,” a “viewpoint record data table,” a “gaze target table,” and the like.

### <<Work Information Table>>

The “work information table” memorizes (stores), for example, data for identifying the work that performs the work. The “work information table” stores, for example, a ‘work ID’ and a ‘work name’ for identifying the work performed by the instructor and the worker.

### <<Work Procedure Table>>

The “work procedure table” memorizes (stores), for example, data on the procedure of the work performed by the instructor and the worker. The “work procedure table” stores, for example, a ‘work procedure ID’ for identifying the procedure of the work, and stores the ‘work ID,’ a ‘work procedure name,’ and ‘work order,’ which mutually correspond, in association with the ‘work procedure ID.’ The “work procedure table” is associated with the “work information table” via, for example, the ‘work ID.’

<<Response information Table>>

The “response information table” memorizes (stores), for example, data for identifying information corresponding to the work displayed by display means after the determination of right/wrong of the work target by determination means based on the video information and the coordinate information of the viewpoint acquired by acquisition means when the worker performs the work.

The “response information table” stores, for example, a ‘response information ID’ for identifying information to deal with the work, the ‘work procedure ID,’ and a ‘display type’ indicating a type of display, for example, ‘prior’ that means the presentation or the like of encouragement by a nudge and prior confirmation information and ‘interrupt type’ displayed depending on the work status including missing.

As the ‘display type,’ for example, like an animation effect timing setting, a trigger of a start timing and a trigger for indicating a display time or a display end are set. When the display type is, for example, ‘interrupt,’ information indicative of a determination timing for performing the interrupt is stored as a “display/determination start condition.” The determination start condition may be one, for example, that specifies a trigger of the interrupt determination.

Further, the “response information table” stores a “determination criterion” indicating a criterion and a threshold with which whether the instructor ‘watched’ or ‘did not watch’ is determined at the transition to the ‘interrupt determination’ and ‘response information content’ that is display content displayed as the response information.

The ‘response information content’ may store, for example, the response information specified by the file name, and additionally, generated at a workplace by markdown or the like. The “response information content” may be generated by, for example, storing a one-time instruction, such as contact with a supervisor or an experienced worker, and inputting it via an editing screen.

Further, the “response information table” stores, for example, a ‘work result record display condition,’ such as a work report and a checklist, indicating conditions of a timing and the like for displaying content that records the result for each work procedure, and ‘work result record content,’ such as a work report and a checklist, indicating content to record the work result.

The attention extraction system 100 may refer to the ‘work result record display condition’ and determine the proper state of the gaze target by image comparison based on a signal by, for example, a gesture or a sound input. For example, the attention extraction system 100 may store various kinds of information and data in the ‘work result record display condition’ as the conditions to store the determination result.

For example, the attention extraction system 100 may be required to input the result of the content in the ‘work result record content.’ For example, the attention extraction system 100 may determine the input of the result to determine that one work procedure has been completed from the determination result. For example, the “response information table” is associated with the “work procedure table” via the ‘work procedure ID.’

### <<Instruction Work Record Table>>

The “instruction work record table” memorizes (stores), for example, various kinds of information on the work performed by the instructor. The “instruction work record table” stores, for example, an ‘instruction work record ID’ for identifying the instruction work to be recorded, an ‘instruction work date and time’ indicating the date and time at which the instruction work is performed, an ‘instruction worker’ indicating the instructor who performs the instruction work, an ‘instruction workplace’ indicating a place and an area in which the instruction work is performed, and the ‘work ID,’ which are mutually associated. For example, an “instruction work storing table” is associated with the “work information table” via the ‘work ID.’

### <<Viewpoint Record Table>>

The “viewpoint record table” memorizes (stores), for example, information and data on the viewpoint of the instructor performing the work acquired by an acquisition unit 11. The “viewpoint record table” stores a ‘viewpoint record ID’ for identifying the viewpoint record in the work performed by the instructor, and a ‘viewpoint record data file’ that is data of coordinate information of the viewpoint acquired by eye-tracking.

The “viewpoint record table” may store stream data acquired in the unit of millisecond. This enables the attention extraction system 100, for example, to store a real file name of data of JavaScript Object Notation (JSON) (JavaScript is a registered trademark) without directly storing the data in the DB.

For example, the “viewpoint record table” stores a “visual field range record video file” indicating data of video information in the visual field range of the instructor recorded by an outer camera. Further, the “viewpoint record table” stores the ‘instruction work record ID’ for identifying a history of the instruction work performed by the instructor. The “viewpoint record table” is associate with the “instruction work record table” via, for example, the ‘instruction work record ID.’

### <<Viewpoint Record Data Table>>

The “viewpoint record data table” stores, for example, a plurality of pieces of detailed information of the coordinate information of the viewpoint acquired by the acquisition unit 11 when the instructor performs the work. The “viewpoint record data table” stores a ‘viewpoint identification data file’ for identifying the file in which the viewpoint record data is stored and a ‘viewpoint recording elapsed time’ indicating a time period of viewpoint identification recorded by the instructor. The ‘viewpoint recording elapsed information’ memorizes (holds), for example, an elapsed time of recording the viewpoint as a record having a recording start of the work start by the instructor as 00:00:00. For example, the ‘viewpoint recording elapsed information’ may be recorded at intervals of a unit time (for example, at 1 second intervals) together with various kinds of position information. The “viewpoint record data table” is associated with the “instruction work record table” via, for example, the ‘viewpoint identification data file.’

The “viewpoint record data table” stores position information of the instruction worker in a workspace as ‘instruction worker position information (X, Y, Z).’ In the ‘instruction worker position information (X, Y, Z),’ for example, a position of a HMD that the instruction worker wears, that is, a three-dimensional coordinate of position information of the head is recorded, and additionally, information, such as ‘instruction worker direction information (rad),’ ‘instruction worker eyeball position information (x, y, z),’ and ‘instruction worker eyeball angle information (rad)’ acquired by the acquisition unit 11, may be stored together. The “viewpoint record data table” is associated with the “instruction work record table” via, for example, the ‘viewpoint record data file.’

### <<Gaze Target Table>>

The “gaze target table” memorizes (stores), for example, various kinds of information regarding a target at which the instructor gazes. A plurality of pieces of various kinds of information set by the evaluator are stored. The “gaze target table” stores, for example, a ‘gaze target ID’ for identifying the target at which the instructor gazes, the ‘visual field range record video file,’ the ‘viewpoint record data file,’ the ‘viewpoint recording elapsed time,’ and the ‘work procedure ID.’

The “gaze target table” stores a ‘visual field range image in gaze’ that is a still image of a moment in the viewpoint recording elapsed time clipped from the ‘visual field range record video file.’ Additionally, the “gaze target table” may store, for example, a ‘gaze target position (x, y)’ indicating a position and a ‘gaze target range (w, h)’ indicating a range regarding the gaze target extracted by an extraction unit 13 and a ‘gaze target image’ indicating an image of the gaze target as the attention information on the work based on the gaze mode identified by an identification unit 12 based on the video information and the coordinate information associated in the “viewpoint record table.”

For example, the attention information may be generated by the identification unit 12 and the extraction unit 13 based on the information acquired by the acquisition unit 11, then evaluated and set by the evaluator, and recorded. For example, the “gaze target table” is associated with the “viewpoint record table” via the ‘gaze target ID,’ associated with the “work procedure table” via the ‘work procedure ID,’ and associated with the “viewpoint record data table” via the ‘viewpoint record data file.’

FIG. 4B is a schematic diagram illustrating exemplary functions of the attention extraction device 1. The attention extraction device 1 includes, for example, the acquisition unit 11, the identification unit 12, the extraction unit 13, the storing unit 14, the determination unit 15, the display unit 16, the input unit 17, and a monitoring display unit 18. The respective functions illustrated in FIG. 5B are achieved by executing programs stored in the storage unit 104 and the like by the CPU 101 with the RAM 103 as a working area.

### <<Acquisition Unit 11 (Acquisition Means)>>

The acquisition unit 11 acquires the video information in the visual field range of the instructor performing the work and the coordinate information indicating the viewpoint at which the instructor gazes in the visual field range in time series order in association with the work. The acquisition unit 11 is used, for example, when an acquiring step S110 described later is performed. The timing of acquiring the video information and the coordinate information from the instructor device 2 by the acquisition unit 11 can be appropriately set. For example, the acquisition unit 11 saves the acquired video information and coordinate information in the storage unit 104 in time series order in association with the work performed by the instructor via the storing unit 14.

### <<Identification Unit 12 (Identification Means)>>

The identification unit 12 obtains the viewpoint displacement of the instructor in the visual field range based on the video information and the coordinate information acquired by the acquisition unit 11, and identifies the gaze mode of the instructor. The identification unit 12 is used, for example, when an identifying step S120 described later is performed. For example, as illustrated in FIG. 3 described above, the identification unit 12 identifies the gaze mode in the visual field range of the instructor based on the video information in the visual field range 2a and the coordinate information (x-axis, y-axis) of the viewpoint displacement of the instructor acquired by the instructor device 2.

Subsequently, the identification unit 12 may identify a feature and a tendency different from the “wide visual field mode” and the “vigilant mode” that have been already stored as an additional mode when they are present in the information acquired by the acquisition unit 11. The identification unit 12 can appropriately set various kinds of modes using the attention extraction device 1. For example, the identification unit 12 changes the acquired existing mode, and further, saves the additional mode in time series order in the storage unit 104 in association with the instructor and the work performed by the instructor via the storing unit 14. In the identification of the various kinds of modes of the instructor by the identification unit 12, for example, the evaluator may set the various kinds of modes based on the information acquired by the acquisition unit 11 and stored in the database.

### <<Extraction Unit 13 (Extraction Means)>>

The extraction unit 13 sets a gazed region based on the gaze mode identified by the identification unit 12, and extracts a gazed image of the work target 6 at which the instructor has gazed in the gazed region. For example, when the identification unit 12 identifies a plurality of the gaze modes, the extraction unit 13 may determine the gazed images of the work target 6 included in the set gazed region based on the respective gaze modes and extract them in time series order.

For example, the extraction unit 13 extracts the gazed images of the work target 6 included in the set gazed region based on the gaze modes. When the work and the confirmation by the instructor are ordered, the gazed images may be extracted in time series order putting emphasis on the order, and when they are not ordered, a plurality of the gazed images may be extracted in association with one work.

For example, the extraction unit 13 may output the extraction result to the storing unit 14, the attention extraction device 1, and the like via the communications network 5. For example, the extraction unit 13 stores the extracted gazed image in the storage unit 104 in association with the instructor, the work performed by the instructor, the gaze mode, and the like via the storing unit 14. In the association of the gazed image with the gaze mode and the like by the extraction unit 13, the evaluator may perform setting based on the various kinds of information stored in the storage unit 104.

### <<Storing Unit 14 (Storing Means, Database)>>

The storing unit 14 stores the gazed image extracted by the extraction unit 13 in the database as the attention information on the work of the instructor in association with the visual field range, the viewpoint displacement, and the gaze mode. The storing unit 14 stores various kinds of information in the storage unit 104, or retrieves the various kinds of information from the storage unit 104.

The storing unit 14 stores a plurality of associations between past gazed image information acquired in advance and reference information indicating right/wrong of the work target associated with the gazed image. For example, the storing unit 14 stores or retrieves the various kinds of information depending on the process contents of the acquisition unit 11, the identification unit 12, the extraction unit 13, the determination unit 15, the display unit 16, the input unit 17, and the monitoring display unit 18.

### <<Determination Unit 15 (Determination Means)>>

For example, the determination unit 15 determines whether the work target included in the gazed image of the work acquired via the worker device 3 of the worker is right or wrong using the attention data set regarding the work. The determination unit 15 refers to the database stored in the storing unit 14 or the storage unit 104, and determines right/wrong of the work for the gaze information (for example, the work target 6 or the like) performed by the worker by referring to the database based on the video information acquired via the worker device 1 of the worker.

For example, the determination unit 15 acquires various kinds of response information from the database depending on the determination result. For example, the determination unit 15 acquires information on the work to be dealt with by the worker, such as target information (“(1) Confirm OK; 01234” and “(2) Adjust Procedure: XXX,” displayed in the visual field range 3a of the worker device 3 in FIG. 2 described above. For example, the determination unit 15 transmits the acquired response information to the display unit 16 of the worker device 3.

For example, when the same work is performed by a plurality of workers in the same work area, the determination unit 15 may collectively determine right/wrong of the work target of the plurality of workers. In this case, for example, the plurality of workers set the attention data set for the common work in the respective worker devices 3 in advance. For example, the determination unit 15 may acquire a plurality of pieces of information for each workspace layout of the work from the coordinate information acquired by the acquisition unit 11 based on a relation between the coordinate information indicating the position and the direction of the head of each worker and the coordinate information indicating the workspace of the work, and determine the works and the work targets of the respective workers in an integrated manner or on a group basis.

Further, the determination unit 15 acquires information on states, for example, whether or not an original worker faces in a right direction with respect to a work target to be originally worked, whether or not there is another worker who can support the original worker when the original worker does not face in the right direction (when the original worker is not aware), whether or not there is another worker who faces in the direction of the work target that the original worker is to work, and the like. For example, the determination unit 15 may transmit the response information to the worker device 3 of another worker who performs the group work at the surrounding area in which the work target can be appropriately worked based on the acquired pieces of information and information on the work processes of the respective workers even when the original worker does not gaze at the work target.

### <<Display Unit 16 (Display Means)>>

For example, the display unit 16 outputs the various kinds of response information acquired by the determination unit 15 to the worker device 3 or the like of the worker who performs response work using the attention data set generated based on the work of instructor. The display unit 16 (the display part 109 of the worker device 3) displays, for example, the various kinds of response information transmitted from the determination unit 15 in the visual field range 3a of the worker device 3 that the worker wears in a manner in which the response information is superimposed on actual video.

For example, when the same work is divided to be performed by a plurality of workers in the same work area, the display unit 16 appropriately displays exercise information acquired from the determination unit 15 depending on the work statuses and the work positions of the respective workers.

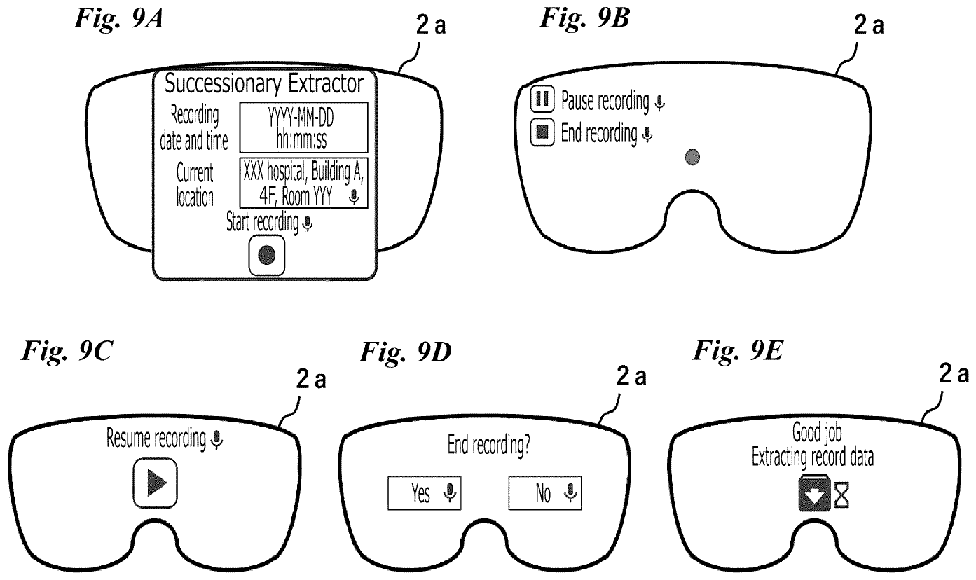

The display unit 16 performs display, for example, for extracting the attention information on the work as illustrated in FIG. 9 on the instructor device 2. FIG. 9 is, for example, schematic diagrams illustrating an exemplary attention extraction method according to the embodiment. For example, before the acquisition of the video information by a hand-acquisition unit 11, the display unit 16 displays recording date and time information, recording location information, and recording control information in the center of the visual field range 2a as illustrated in FIG. 9A. For example, during the acquisition of the video information by the acquisition unit 11, the display unit 16 may change the display to the display of only the recording control information (for example, “pause recording,” “end recording,” and the like) at a corner of the visual field range 2a.

For example, as illustrated in FIGS. 9C to 9E, the display unit 16 may perform display for instructing respective operations in the center of the visual field range 2a of the instructor device 2. The display by the display unit 16 may include, for example, a work process that has been scheduled by the instructor, a work result performed by the instructor, and timings of a break and the end of the work detected by a position detection sensor preliminarily provided in the instructor device 2.

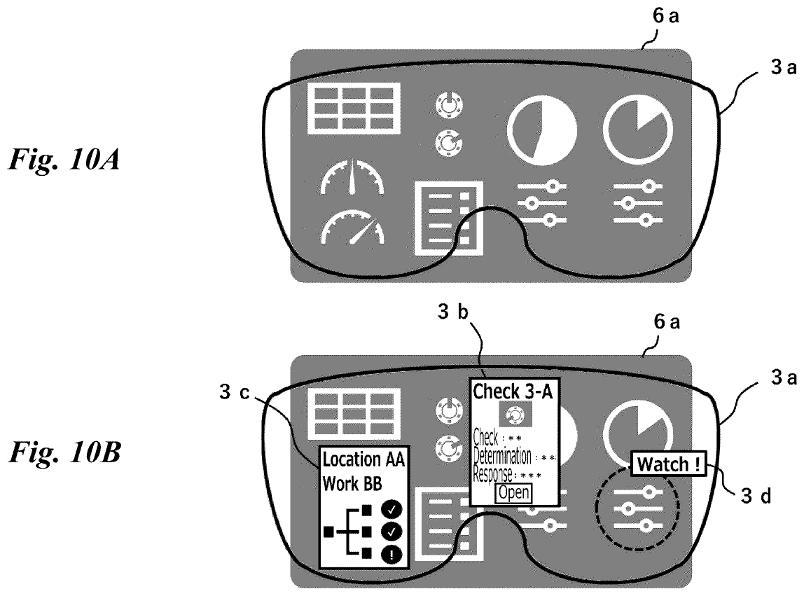

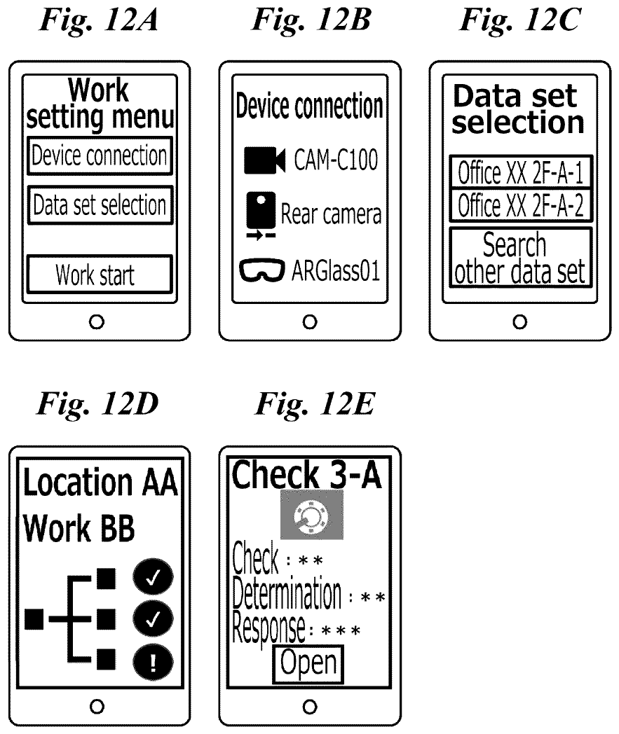

The display unit 16 performs display on the worker device 3, for example, as illustrated in FIGS. 10A and 10B and FIGS. 12A to 12E. FIGS. 10A and 10B are schematic diagrams illustrating exemplary attention extraction using, for example, the above-described attention data set of the embodiment displayed when the worker performs the work via the worker device 3. FIGS. 12A to 12E are, for example, schematic diagrams illustrating exemplary displays of the worker device 3 (a worker terminal, a smartphone, a display device, and the like) that the worker holds in the embodiment.

The display unit 16 displays the determination result by the determination unit 15, for example, on a gaze target 6a included in the visual field range 3a of the worker device 3 that the worker wears, a display device that the worker is holding, or the like depending on the result of the determination by the determination unit 15. Further, the display unit 16 displays the response information corresponding to the determination result acquired by the determination unit 15 with reference to the database.

FIG. 10A illustrates a display of the visual field range 3a in a state where, for example, the worker is working and there is no response information on the worker. FIG. 10B illustrates a display of the visual field range 3a in a state where, for example, the worker is working and there is response information on the worker. In the visual field range 3a, as the response information, a point to be originally gazed at (a correct gaze target in the visual field range 3a: circle mark+“WATCH!”), a procedure and related information to be confirmed or referred to by the worker (center of the visual field range 3a: “Check-3-A,” “Check,” “Determination,” “Response,” “Reference Destination,” and the like), and a work status and a check result of the worker himself/herself or a worker of the group work (left side of the visual field range 3a: a work place, a work content, work progress, and the like) are displayed.

Further, the display unit 16 may further include an attention information display area that displays an acquisition display area and an attention display area to be mutually switched. The acquisition display area is displayed, for example, at the work start by the worker, and indicates the type of the acquisition unit 11 that acquires the video information, the type of the attention data set stored in the database, and an instruction to cause each worker to select the work start. The attention display area indicates the response information and the attention information corresponding to the gazed image of the worker based on the attention data set selected by the worker.

Further, for the attention information displayed in the visual field range 3a of the worker device 3, the display unit 16 may appropriately display, for example, information indicated at a timing of at least any of the work start, the middle of the work, or the work end corresponding to the work progress of the worker as nudge information. For example, the display unit 16 refers to an attention database to acquire the response information, the attention information, the nudge information, or the like based on the attention data set and the determination result by the determination unit 15, and displays the acquired various kinds of information by distributing the information corresponding to the gaze situation of the worker performing the work.

The nudge information displayed by the display unit 16 may be displayed, for example, as an approach indicated to the worker, like a nudge default that does not make a target person aware (unconsciously encouraging), a prompt (naturally encouraging), a nudge that makes the worker aware while the selection is left to the worker, labeling (intentionally encouraging), and an incentive (encouraging with a reward). The display of the nudge information may be associated with, for example, the work process and the work progress, the personality, the temperament, and the evaluation of the worker, the degree of difficulty and an assumed end time of the work, and the like of the work. The nudge information may be appropriately extracted from the database and displayed depending on the actual work progress of the worker.

For the display of the nudge information, for example, in addition to directly displaying the reference information provided as a result display candidate of the determination by the determination unit 15, the display unit 16 may randomly display a pattern of asking a question, for example, “All right?” and “Wait a minute?” The display unit 16 may perform random display at a corresponding position of the gaze target 6a at the center of the visual field range 3a or in the visual field range 3a of the worker device 3.

The display unit 13 may appropriately set and display, for example, an output method of the display in which some methods are mixed or randomly changed (visual, auditory, haptics (vibration), the approach of nudge information (labeling), the method of nudge information (talking to, simply expressing, causing a question, completely changing) depending on the skill of the worker and the progress of the work.

For example, for the nudge information to be displayed, the display unit 16 may perform display for avoiding missing the reference information due to habituation, boredom, and expectation of maintaining the status quo with heuristic, normality (the maintenance of the status quo), and a change as a related bias. For example, the display unit 16 may include means (not illustrated) for obtaining a flow and a procedure of the entire work that the worker is performing as a prerequisite process for displaying the nudge information, and further include means (not illustrated) for detecting departure from attention to be paid.

For example, when the work performed by the worker is ended, the display unit 16 may display words for appreciating the worker with reference to the database, and any kind of the nudge information is displayed at any timing. This allows, for example, displaying the response information indicated to the worker with a change, and allows avoiding missing the reference information due to habituation, boredom, and expectation of maintaining the status quo of the worker.

Further, the display unit 16 performs display, for example, as illustrated in FIG. 11 on the attention extraction device 1. In FIG. 11, for example, the gaze monitoring area of the attention extraction device 1 according to the embodiment is illustrated as the attention extraction device screen 1a. As described above, for example, the evaluator causes the display unit 16 to display the coordinate information, the gazed region, the gazed image, and the gaze transition in the work performed by the instructor in time series order in the gaze display area 1b with reference to the database via the attention extraction device 1.

For example, as illustrated in FIG. 11, the display unit 16 displays the setting information for performing setting on the gazed image displayed in the gaze display area 1b in the target setting area 1c. Further, for example, the display unit 16 displays the determination condition of the setting information displayed in the target setting area 1c in the determination setting area 1d.

For example, the display unit 16 displays the setting information for performing setting on the gazed image displayed in the gaze display area 1b in the target setting area 1c. Further, for example, the display unit 16 displays the determination condition of the setting information displayed in the target setting area 1c in the determination setting area 1d.

### <<Input Unit 17 (Input Means)>>

The input unit 17 inputs, for example, the response information output by the determination unit 16. The input unit 17 accepts, for example, various kinds of setting and the conditions and the values regarding the adjustment from the evaluator via, for example, the attention extraction device screen 1a displayed on the attention extraction device 1, and additionally, performs acceptance via, for example, the setting item menu displayed on the attention extraction device screen 1a. Accordingly, for example, the acquisition unit 11, the identification unit 12, the extraction unit 13, the storing unit 14, the determination unit 15, the display unit 16, and the monitoring display unit 18 perform various kinds of processes based on the various kinds of conditions and values accepted by the input unit 17.

The response information input by the input unit 17 is associated with the gazed image, and stored in the database of the server 4 as the attention data set including the setting condition for recognizing the gaze target.

### <<Monitoring Display Unit 18 (Monitoring Display Means)>>

For example, the monitoring display unit 18 displays various kinds of information that the evaluator refers to or uses to perform setting of the work of the instructor on the attention extraction device screen 1a as the gaze monitoring area. For example, the monitoring display unit 18 displays the gaze display area 1b indicating the coordinate information, the gazed region, the gazed image, and the gaze transition stored in the database in time series order, the target setting area 1c indicating setting information for performing setting of the gazed image displayed in the gaze display area, and the determination setting area 1d indicating determination conditions of the setting information displayed in the target setting area.

For example, the attention extraction device 1 acquires the video information regarding the work via the instructor device 2 of the instructor. For example, the work performed by the instructor may be preliminarily selected for each of the various kinds of attention data sets that are set corresponding to the work of the worker, and a gaze data set of the work of the instructor may be generated with the attention data set corresponding to the selected work.

The attention data set extracted by the attention extraction device 1 is selected by, for example, workers A to C, and the works of the workers to C are evaluated using the selected attention data set. For example, the evaluator may monitor the work statuses of the workers A to C performing the work using the attention data set via the attention extraction device 1. For example, the attention extraction device 1 may acquire the work states of the workers A to C together with the work using the gaze data set, and for example, may acquire the images and the position information of the work target by the worker devices 1 that the respective workers wear and display them on the display unit 16 of the attention extraction device 1.

For example, the evaluator may refer to the work statuses of the workers A to C indicated in the attention extraction device screen 1a displayed on the attention extraction device 1, and when work or evaluation different from those of the attention data set occurs, for example, in a case where the worker C fails to perform original work (skips the work order and is in front of another work target), and the worker B is at a position at which the original work of the worker C is confirmable, the evaluator may set the work regarding the gaze information which the worker C is originally to gaze at to “ignored” and set the work regarding the gaze information that the worker B is to gaze at to “replace” to give an instruction in real time.

### <Instructor Device 2>

The instructor device 2 is worn by the instructor of the work, and additionally, for example, worn by an expert, a qualified person, and the like, and used to acquire the video information seen by the instructor through the work of the instructor. The instructor device 2 may be, for example, publicly known eye-tracking technology, head-mounted display, or smart glasses, and may acquire voice, nearby sound information, temperature, humidity, position information, space information, and the like together with the video information.

For example, the instructor device 2 is connected to the attention extraction device 1, another instructor device 2, the worker device 3, and the server 4 in a state where data communication can be performed, and further, for example, the instructor device 2 may include the attention extraction device 1.

### <Worker Device 3>

The worker device 3 is worn by the worker who performs the work, and additionally, for example, worn by a person other than the instructor, and used to acquire the video information seen by the worker through the work of the worker. The worker device 3 may be, for example, publicly known eye-tracking technology, head-mounted display, or smart glasses, and may acquire voice, nearby sound information, temperature, humidity, position information, space information, and the like together with the video information.

For example, the worker device 3 is connected to the attention extraction device 1, the instructor device 2, another worker device 3, and the server 4 in a state where data communication can be performed, and further, for example, the worker device 3 may include the attention extraction device 1.

### <Communications Network 5>

The communications network 5 is, for example, an Internet network in which the attention extraction device 1, the instructor device 2, and the worker device 3 are connected via a communication circuit, and may be configured of an optical fiber communications network. The communications network 5 can be achieved by a publicly known communications network including a wired communication network, a wireless communication network, and the like.

### <Learning Model>

The learning model generates, for example, a database by machine learning. For example, the learning model includes a learning target image including the gazed image taken by the instructor device 2 and the reference information indicating right/wrong of the gazed image taken by the instructor device 2 as a pair of learning data, and a plurality of pairs of learning data are acquired for each work in the instructor device 2. The learning model is generated by the database that stores the association between a plurality of learning target images and a plurality of pieces of reference information through the machine learning using a plurality of pairs of learning data.

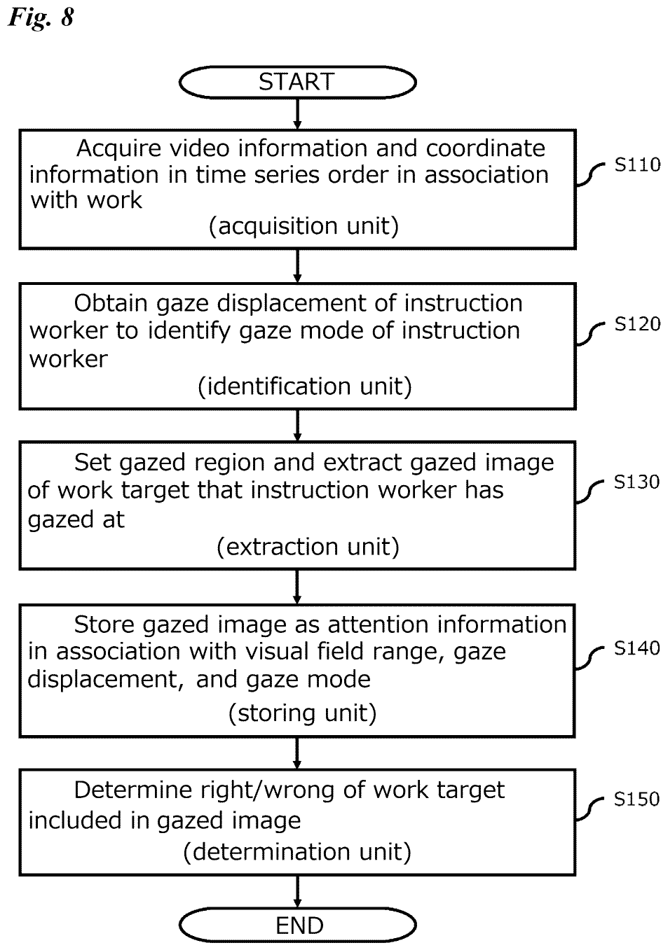

FIG. 8 is a schematic diagram illustrating an exemplary attention extraction method according to the embodiment. The attention extraction method includes an acquiring step S110, an identifying step S120, an extracting step S130, a storing step S140, and a determining step S150. The attention extraction method can be performed using the attention extraction system 100.

### <Acquiring Step S110>

The acquiring step S110 acquires, for example, the video information and the coordinate information in time series order in association with the work. The acquiring step S110 performs the acquisition, for example, using the instructor device 2 including a publicly known camera or imaging device. The acquiring step S110 may acquire, for example, the video information and the coordinate information from the worker device 3 in time series order in association with the work. The acquiring step S110 acquires, for example, the video information and the like using devices selected by the instructor and the worker.

### <Identifying Step S120>

The identifying step S120 obtains the viewpoint displacement of the instructor to identify the gaze mode of the instructor. For example, the identifying step S120 obtains the viewpoint displacement in the visual field range of the instructor based on the video information and the coordinate information acquired in the acquiring step S110 to identify the gaze mode of the instructor.

For example, the identifying step S120 identifies the gaze mode of the instructor as the “wide visual field mode” when the viewpoint displacement of the instructor has a feature of being included in the visual field radius of the instructor of 5 degrees to 20 degrees and aggregated in the center of the visual field range. For example, the identifying step S120 identifies the gaze mode of the instructor as the “vigilant mode” when the viewpoint displacement of the instructor has a feature of being included within the visual field radius of the instructor of 4 degrees and decentralized to the outside of the center of the visual field range.

For example, the identifying step S120 identifies the gaze mode in the visual field range of the instructor as the “wide visual field mode” and the “vigilant mode” based on the video information in the visual field range 2a and the coordinate information (x-axis, y-axis) of the viewpoint displacement of the instructor acquired by the instructor device 2. While, for example, the identifying step S120 identifies the gaze mode as the “wide visual field mode” and the “vigilant mode” based on the coordinate information of the viewpoint displacement of the instructor, the identifying step S120 may additionally set a confirmed gaze mode when other feature and tendency can be confirmed.

### <Extracting Step S130>

For example, the extracting step S130 sets the gazed region and extracts the gazed image of the work target that the instructor has gazed at. For example, the extracting step S130 sets the gazed region that the instructor gazes at based on the gaze mode (for example, the “wide visual field mode” and the “vigilant mode”) identified in the identifying step S120. For example, the extracting step S130 extracts the gazed image of the work target that the instructor has gazed at from the video information of the instructor in the set gazed region.

For example, when a plurality of the gazed images are included in the video information in the gazed region of the instructor, the extracting step S130 may perform the extraction based on gazed order or a gazed time. For example, the extracting step S130 extracts the gazed image of the work target from the video information in the gazed region that the instructor gazes at corresponding to the condition set by the evaluator. This allows obtaining the state of gaze of the instructor to extract the appropriate attention information.

### <Storing Step S140>

For example, the storing step S140 stores the gazed image as the attention information in association with the visual field range, the viewpoint displacement, and the gaze mode. For example, the storing step S140 associates the gazed image extracted in the extracting step S130 with the visual field range, the viewpoint displacement, and the gaze mode, and stores them in the database as the attention information on the work as described above.

### <Determining Step S150>

For example, the determining step S150 determines right/wrong of the work target included in the gazed image acquired via the worker device 3 using the attention data set. For example, the determining step S150 determines right/wrong of the work target based on the gazed image acquired by the worker device 3 in the acquiring step S110. For example, in addition to the evaluation using the attention data set for each selected work, the determining step S150 may perform determination based on the evaluation by the evaluator who monitors the work via, for example, the attention extraction device 1.

For example, the determining step S150 may determine right/wrong of the work target on which the worker performs the work based on the attention data set preliminarily selected in the worker device 3 when the gazed image is acquired by the worker device 3 in the acquiring step S110. The determining step S150 may determine the works of a plurality of the workers in the same work area.

For example, the determining step S150 may simultaneously determine the works performed by the plurality of workers with the same or common attention data set. This allows performing the determination corresponding to the work positions and the work statuses of the respective workers, for example, when one worker has missed or skipped a process, or when the work processes are performed in random order.

The determining step S150 refers to various kinds of data tables and the like, for example, the “work information table,” the “work procedure table,” the “response information table,” the “instruction work record table,” the “viewpoint record table,” the “viewpoint record data table,” and the “gaze target table,” stored in the database, determines right/wrong of the work target based on the various kinds of data tables and the gaze data set, and acquires response work and the various kinds of response information stored in a reference link corresponding to the determination result. The response information acquired by the determining step S150 may be displayed on, for example, the worker devices 3 of the corresponding instruction worker and other workers.

For example, the determining step S150 inputs addition and update of the response information of the various kinds of data tables stored in the database via the input unit 17. For example, the input unit 17 can appropriately input the work process, the determination condition, the response work, the reference link, and the like of an identified target and a determination target stored in each of the various kinds of data tables.

Thus, the operation of the attention extraction device 1 according to the embodiment is ended.

According to the embodiment, for example, the attention extraction device 1 acquires the video information via the acquisition unit 11 of the instructor device 2. The video information may include, for example, the recording date and time information and the recording location information of the work performed by the instructor, and the recording control information regarding the acquisition operation of the video information.

According to the embodiment, for example, the display unit 11 switches the display of the instructor device 2 as illustrated in FIG. 9. For example, the display unit 11 displays the recording date and time information, the recording location information, and the recording control information in the center of the visual field range before the acquisition of the video information by the acquisition unit 11. The acquisition unit 11 switches the display to indicate only the recording control information at the corner of the visual field range during the acquisition of the video information. This allows the display without interference with the work of the instructor.

According to the embodiment, the display unit 16 displays the attention information. For example, the displayed information includes nudge information based on the theory of nudge at a timing of the work start, the middle of the work, or the work end corresponding to the information on the work progress, the work status, and the like of the work performed the worker. This allows eliminating a bias affecting a dialogue with a conventional computer system or information, and displaying nudge indication based on the theory of nudge enables enhancing the effect of notification from the attention extraction system device 1.

While the embodiment of the present invention has been described, the above-described embodiment is presented as an example, and it is not intended to limit the scope of the invention. The novel embodiment described above can be embodied in other various configurations, and various kinds of omissions, replacements, and changes can be made without departing from the gist of the invention. The above-described embodiment and its modifications are included in the scope and the gist of the invention, and included in the invention described in claims and its equivalent.

### DESCRIPTION OF REFERENCE SIGNS

1: Attention extraction device
1a: Attention extraction device screen
1b: Gaze display area
1c: Target setting area
1d: Determination setting area
1e: Work space map
1f: Work substitution flag
2: Instructor device
2a: Visual field range (instructor)
2b: Gaze mode
3: Worker device
3a: Visual field range (worker)
4: Server
5: Communications network
6: Work target
6a: Gaze target
10: Housing
11: Acquisition unit
12: Identification unit
13: Extraction unit
14: Storing unit (database)
15: Determination unit
16: Display unit
17: Input unit
18: Monitoring display unit
50: Work area
100: Attention extraction system
S110: Acquiring step
S120: Identifying step
S130: Extracting step
S140: Storing step
S150: Determining step

1. An attention extraction system for extracting attention information on work, comprising:
acquisition means that acquires video information in a visual field range of an instructor who performs the work and coordinate information indicating a viewpoint that the instructor gazes at in the visual field range in time series order in association with the work;
identification means that identifies a gaze mode of the instructor as a wide visual field mode or a vigilant mode based on the video information and the coordinate information acquired by the acquisition means, the wide visual field mode being identified when the coordinate information in time series order indicating a viewpoint displacement of the instructor in the visual field range is aggregated in a center of the visual field range, the vigilant mode being identified when the coordinate information in time series order indicating the viewpoint displacement of the instructor in the visual field range is decentralized to an outside of the center of the visual field range;
extraction means that sets a gazed region based on the gaze mode identified by the identification means, and extracts a gazed image of a work target that the instructor has gazed at in the gazed region; and
storing means that associates the gazed image extracted by the extraction means with the visual field range, the viewpoint displacement, and the gaze mode, and stores them in a database as attention information on the work.

2. The attention extraction system according to claim 1, wherein
the acquisition means further includes:
determination means that acquires a gazed image of a worker who performs work, and determines right/wrong of the work performed on a work target by the worker based on video information included in the gazed image and target information on work to be dealt with by the worker, the target information being stored in a database in advance; and
display means that displays a determination result of the determination means.

3. The attention extraction system according to claim 2, further comprising
a database that stores an association between past gazed image information acquired in advance and reference information indicating the right/wrong of the work target associated with the gazed image, wherein
the determination means refers to the database to determine the right/wrong of the work target, and acquires response information corresponding to a result of the determination from the database, and
the display means further outputs the response information acquired by the determination means.

4. The attention extraction system according to claim 2, further comprising
input means that inputs response information output by the determination means, wherein
the storing means associates the response information input by the input means with the gazed image, and stores them as an attention data set including a setting condition for recognizing a gaze target.

5. The attention extraction system according to claim 2, wherein
the video information acquired by the acquisition means includes recording date and time information and recording location information of the work performed by the instructor, and recording control information regarding an acquisition operation of the video information, and
the display means displays the recording date and time information, the recording location information, and the recording control information in a center of the visual field range before the acquisition of the video information by the acquisition means, and switches the display to indicate only the recording control information at a corner of the visual field range during the acquisition of the video information.

6. The attention extraction system according to claim 2, wherein
the display means further includes an attention information display area that displays an acquisition display area and an attention display area to the worker who performs the work while the acquisition display area and the attention display area are mutually switched, the acquisition display area indicating a type of the acquisition means that acquires the video information, a type of the attention data set stored in the database and including a setting condition for recognizing the gaze target, and an instruction for causing each worker to select a start of the work, the attention display area indicating response information corresponding to the gazed image of the worker and attention information based on the attention data set after the selection,
the attention information indicated in the attention display area includes nudge information indicated at a timing of at least any of a work start, a middle of the work, or a work end corresponding to work progress of the worker, and
information including at least any of the response information, the attention information, or the nudge information indicated in the attention information display area is distributed to be displayed depending on a gaze state of the worker who performs the work based on the attention data set and the determination result of the determination means.

7. An attention extraction method for extracting attention information on work, comprising:
an acquiring step of acquiring video information in a visual field range of an instructor who performs the work and coordinate information indicating a viewpoint that the instructor gazes at in the visual field range in time series order in association with the work;
an identifying step of identifying a gaze mode of the instructor as a wide visual field mode or a vigilant mode based on the video information and the coordinate information acquired by the acquiring step, the wide visual field mode being identified when the coordinate information in time series order indicating a viewpoint displacement of the instructor in the visual field range is aggregated in a center of the visual field range, the vigilant mode being identified when the coordinate information in time series order indicating the viewpoint displacement of the instructor in the visual field range is decentralized to an outside of the center of the visual field range;
an extracting step of setting a gazed region based on the gaze mode identified by the identifying step, and extracting a gazed image of a work target that the instructor has gazed at in the gazed region; and
a storing step of associating the gazed image extracted by the extracting step with the visual field range, the viewpoint displacement, and the gaze mode, and storing them in a database as attention information on the work, wherein
the steps are executed by a computer.
